(19) United States
(12) Patent Application Publication
(10) Pub. No.: US 2005/0018104 A1
(43) Pub. Date: Jan. 27, 2005

(54) Method of guiding light, light guiding apparatus, back light assembly and liquid crystal display device having the same

(76) Inventors: Sang-Duk Lee, Yongin-si (KR); Jung-Tae Kang, Suwon-si (KR); Kyu-Seok Kim, Yongin-si (KR); Jae-Ho Jung, Yongin-si (KR); Hyun-Chul Bae, Seoul (KR)

Correspondence Address: CANTOR COLBURN LLP, 55 Griffin Road South, Bloomfield, CT, 06002, US

(21) Appl. No.: 10/608,940

(22) Filed: Jun. 26, 2003

(30) Foreign Application Priority Data
Jan. 1, 2003 (KR) 2003-324

(51) Int. Cl. G02F 1/1335

(52) U.S. Cl. 349/65

(57) ABSTRACT

Disclosed are a method and a device for guiding light, and a back light assembly and a liquid crystal display device having the device for guiding light for reducing a bright line appearing in a liquid crystal display panel. When the ridge of the prism light guide plate, which is disposed adjacent to the light incident face is formed round; when a shape of the lamp cover is transformed to cover an upper edge portion of the light guide plate; when the light-shielding member is attached on a region of the light luminance control member, that is disposed adjacent to the light incident face of the light guide plate; and when the light incident face of the light guide plate is disposed as far from a border of an active display region as possible, the bright line is reduced.

### CROSS-REFERENCE TO RELATED APPLICATIONS

This application relies for priority upon Korean Patent Application No.2003-324 filed on Jan. 1, 2003, the contents of which are herein incorporated by reference in its entirety.

### BACKGROUND OF THE INVENTION

1. Field of the Invention

The present invention relates to a method of guiding light, a light guiding apparatus, a back light assembly and a liquid crystal display device having the same, and more particularly to a method and an apparatus for guiding light restraining a luminance line, a back light assembly and a liquid crystal display device.

2. Description of the Related Art

A liquid crystal display (LCD) device is a one of the flat panel display device. Generally, the liquid crystal display device includes a liquid crystal display panel having a lower substrate, an upper substrate and liquid crystal layer interposed between the lower substrate and the upper substrate. An image voltage is applied to the liquid crystal layer to regulate an array of liquid crystal molecule. Then, optical characteristics, such as birefringence, dichroism and diffusion of the liquid crystal layer are changed, so that an image is displayed on the liquid crystal display panel.

The liquid crystal display device needs light source to display an image. The liquid crystal display device may, use natural light incident from front face of the liquid crystal display panel, or the liquid crystal display device may use the light generated from a back light assembly disposed under the liquid crystal display panel.

The back light assembly includes a lamp unit, a light guide plate, a reflection sheet and an optical sheet. The lamp unit generates light. The light guide plate guides the light generated from the lamp unit toward the liquid crystal display panel. The reflection sheet is disposed on a bottom face of the light guide plate and reflects the light leaked from the bottom face of the light guide plate toward the light guide plate. The optical sheet enhances the luminance of the light exiting from the light guide plate.

A light guide plate employs prism light guide plate or diffusion light guide plate so as to enhance the luminance.

The prism light guide plate includes a minute prism formed on the bottom face of the light guide plate. The prism is elongated in a direction perpendicular to a longitudinal direction of the lamp.

The diffusion light guide plate also includes a minute prism elongated in a direction perpendicular to a longitudinal direction of the lamp. However, the diffusion light guide plate further includes diffusing agents. The diffusing agents are added into the light guide plate. An inverse prism sheet may be disposed on the prism light guide plate or on the diffusion prism light guide plate. The prism light guide plate and the diffusion light guide plate enhance the luminance and need only one inverse prism sheet. Therefore, the liquid crystal display device may be manufactured in a thin structure at with a low cost.

However, the prism light guide plate has some demerits, such as bright lines and the deterioration of display quality. The bright line appears on a specific region of the liquid crystal display panel, which is near a lamp. The bright line that appears on the liquid crystal display panel is parallel to a longitudinal direction of the lamp. The bright line is generated due to the light incident into an upper edge of the light guide plate from a light incident face of the light guide plate.

### SUMMARY OF THE INVENTION

Accordingly, the present invention is provided to substantially obviate one or more problems due to limitations and disadvantages of the related art.

It is a feature of the present invention to provide a method for guiding light. A first light generated from a light source is received. The first light is guided to refract a first portion of the first light toward the liquid crystal display panel and to refract a second portion of the first light toward an opposite direction to transform the second portion of the first light into a second light. The second light is reflected toward the liquid crystal display panel. The second light is diffusively refracted by a first amount to transform the second light into a third light. The third light is guided to refract a third portion of the third light toward the liquid crystal display panel and to refract a fourth portion of the third light toward the opposite direction to transform the fourth portion of the third light into a fourth light. The fourth light is reflected toward the liquid crystal display panel. The fourth light is diffusively refracted by a second amount to transform the fourth light into a fifth light, such that the second amount is larger than the first amount. The fifth light is refracted toward the liquid crystal display panel.

In one aspect of the present invention, there is provided a light guide plate.

The light guide plate includes a light incident face, a rear face, a first side face, a second side face, a bottom face and a light exiting face. Light generated from a light source is incident onto the light exiting face. The rear face faces the light incident face. The first side face connects the light incident face with the rear face. The second side face connects the light incident face with the rear face, and the second side face faces the first side face. The bottom face has a plurality of prisms elongated in a first direction. Each of the prisms has a first portion and a second portion. The first portion is adjacent to the light incident face. The second portion is adjacent to the rear face. A cross-section of the first portion has a ripple-shape. A ridge of the first portion is round. The light exiting face faces the bottom face.

In another aspect of the present invention, there is provided a lamp cover.

The lamp cover covers a lamp and reflects a light generated from the lamp toward a light incident face of a light guide plate. The lamp is disposed adjacent to the light incident face. The lamp cover includes a body portion, a lower portion and an upper portion. The body portion faces the light incident face of the light guide plate. The lower portion is elongated from a lower end of the body portion toward a lower face of the light guide plate. The upper portion is elongated from an upper end of the body portion toward an upper face of the light guide plate. The upper portion includes a covering portion for covering an upper edge adjacent to the light incident face of the light guide plate.

In another aspect of the present invention, there is provided a back light assembly. The back light assembly includes a light source, a light guide plate and a light luminance control member. The light source generates a first light. The light guide plate includes i) a light incident face onto which a light generated from a light source is incident, ii) a rear face facing the light incident face, iii) a first side face connecting the light incident face with the rear face, iv) a second side face connecting the light incident face with the rear face, the second side face facing the first side face, v) a bottom face having a plurality of prisms elongated in a first direction, the prisms having a first portion and a second portion, the first portion being adjacent to the light incident face, the second portion being adjacent to the rear face, a cross-section of the first portion having a ripple-shape, a ridge of the first portion being round, vi) a light exiting face facing the bottom face. The light luminance control member is disposed on the light guide plate, for controlling luminance of a second light guided by the light guide plate.

In another aspect of the present invention, there is provided a liquid crystal display device. The liquid crystal display device includes a back light assembly and a liquid crystal display panel. The back light assembly includes (a) a light source for generating a first light, (b) a light guiding member having i) a light incident face onto which a light generated from a light source is incident, ii) a rear face facing the light incident face, iii) a first side face connecting the light incident face with the rear face, iv) a second side face connecting the light incident face with the rear face, the second side face facing the first side face, v) a bottom face having a plurality of prisms elongated in a first direction, the prisms having a first portion and a second portion, the first portion being adjacent to the light incident face, the second portion being adjacent to the rear face, a cross-section of the first portion having a ripple-shape, a ridge of the first portion being round, vi) a light exiting face facing the bottom face, (c) a light luminance control member, disposed on the light guide member for controlling luminance of a second light guided by the light guiding member. The liquid crystal display panel assembly displays an image. The liquid crystal display panel includes an array substrate, a color filter substrate disposed over the array substrate and a liquid crystal layer interposed between the array substrate and the color filter substrate.

As described above, when the ridge of the prism light guide plate, which is disposed adjacent to the light incident face is formed round, the bright line is reduced.

When a shape of the lamp cover is transformed to cover an upper edge portion of the light guide plate so that the light that is incident from the, upper edge portion of the light guide plate decreases, the bright line is reduced.

When the light-shielding member is attached on a region of the light luminance control member, that is disposed adjacent to the light incident face of the light guide plate, the bright line is reduced.

When the light incident face of the light guide plate is as far from the virtual line that divides the liquid crystal display panel into an active display region and a non-active display region as possible, the bright line is reduced.

According to the method of guiding light, lamp cover, light guide plate and liquid crystal display device, the light exiting from an upper edge of the light guide plate is reduced, so that a bright line that appears on a liquid crystal display panel deceases.

### BRIEF DESCRIPTION OF THE DRAWINGS

The above and other features and advantages of the present invention will become more apparent by describing in detail the preferred embodiments thereof with reference to the accompanying drawings, in which:

FIG. 1 is an exploded perspective view showing a back light assembly according to a first exemplary embodiment of the present invention;

FIG. 2 is a schematic view showing a light path in a light-guide plate;

FIG. 3 is a perspective view showing the light-guide plate of FIG. 1;

FIG. 4 is a cross-sectional view showing a light guide plate taken along the line A-A′ of FIG. 3;

FIG. 5 is a cross-sectional view showing a light guide plate taken along the line B-B′ of FIG. 3;

FIG. 6A is a cross-sectional view of a light incident face of a flat type light guide plate according to a second exemplary embodiment;

FIG. 6B is a cross-sectional view of the opposite face facing the light incident face of the flat type light guide plate according to the second exemplary embodiment;

FIG. 7A is a cross sectional view showing a lamp cover of a back light assembly according to a third exemplary embodiment;

FIG. 7B is a cross-sectional view showing a lamp cover of a back light assembly according to a fourth exemplary embodiment;

FIG. 7C is a cross-sectional view showing a lamp cover of a back light assembly according to a fifth exemplary embodiment;

FIG. 7D is a cross-sectional view showing a lamp cover of a back light assembly according to a sixth exemplary embodiment;

FIG. 8 is a cross-sectional view showing a liquid crystal display device according to a seventh exemplary embodiment;

FIG. 9 is a cross-sectional view showing a liquid crystal display device according to an eighth exemplary embodiment;

FIG. 10 is a cross-sectional view showing a liquid crystal display device according to a ninth exemplary embodiment; and

FIG. 11 is a cross-sectional view showing a liquid crystal display device according to a tenth exemplary embodiment.

### DESCRIPTION OF PREFERRED EMBODIMENTS

Hereinafter the preferred embodiment of the present invention will be described in detail with reference to the accompanying drawings.

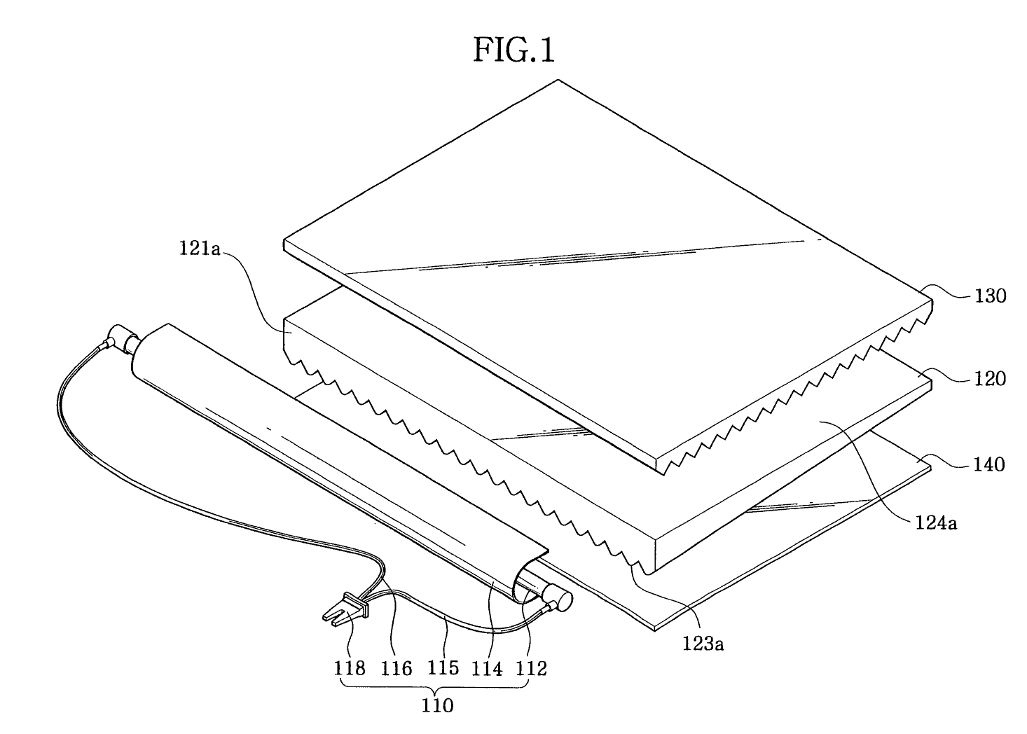

FIG. 1 is an exploded perspective view showing a back light assembly according to a first exemplary embodiment of the present invention.

Referring to FIG. 1, the back light assembly 100 includes a light generating part 110, a light guide plate 120, a light luminance control member 130 and a reflection sheet 140.

The light generating part 110 includes a lamp 112, a lamp cover 114, a first wire 115, a second wire 116 and a connector 118. The connector 118 is electrically connected to the power source (not shown). A power is applied to the lamp 112 via the first wire 115 and the second wire 116.

The lamp cover 114 enwraps a portion of the lamp 112 and covers a portion of a light incident face 121a of the light guide plate 120, so that the light incident into the lamp cover 114 is reflected by the lamp cover 114 and advances toward the light incident face 121a of the light guide plate 120.

The light guide plate 120 is interposed between the light luminance control member 130 and a reflection sheet 140. A bottom face of the light guide plate 120 includes a plurality of first prisms elongated in a direction, which is perpendicular to a longitudinal direction of the lamp 112. The light guide plate 120 guides a first light generated from the lamp 112 and a second light reflected from the reflection sheet 140 toward the light luminance control member 130.

The prisms elongated in the direction have a first portion and a second portion. The first portion is adjacent to the light incident face 121a, and the second portion is adjacent to the opposite face facing the light incident face 121a. The cross-section of the first portion has a ripple-shape. A ridge of the first portion may have a round shape. For example, the ridge of the first portion may have a circle or a parabola shape. The cross-section of the second portion far from the light incident face 121a has a saw-tooth shape. A ridge of the second portion may have a round shape or a valley of the ripple-shape is sharp.

A shape of the prism is round. For example, the shape of the prism may be circular, elliptical, parabolic or hyperbolic. As a virtual point that is disposed on the ridge advances from the light incident face 121 according to a longitudinal direction of the prism, a curvature of the virtual point increases.

The light luminance control member 130 is disposed on the light guide plate 120. The light luminance control member 130 regulates the luminance of the light guided by the light guide plate 120. The light luminance control member 130 may be an inverse prism sheet having a plurality of second prisms. The second prisms face the light guide plate 120. The longitudinal direction of the second prisms of the inverse prism sheet is substantially perpendicular to the longitudinal direction of the first prisms of the light guide plate 120. A valley of the first prisms or the second prisms may be round or sharp.

The reflection sheet 140 is disposed under the light guide plate 120. The reflection sheet 140 reflects the light leaked from the light guide plate 120 toward the light guide plate 120. A reflection plate (not shown) may replace the reflection sheet 140.

When the ridge of the first portion of the first prisms of the light guide plate 120 has a round shape, the bright line appearing on the liquid crystal display panel adjacent to the upper edge of the light guide plate 120 may be reduced.

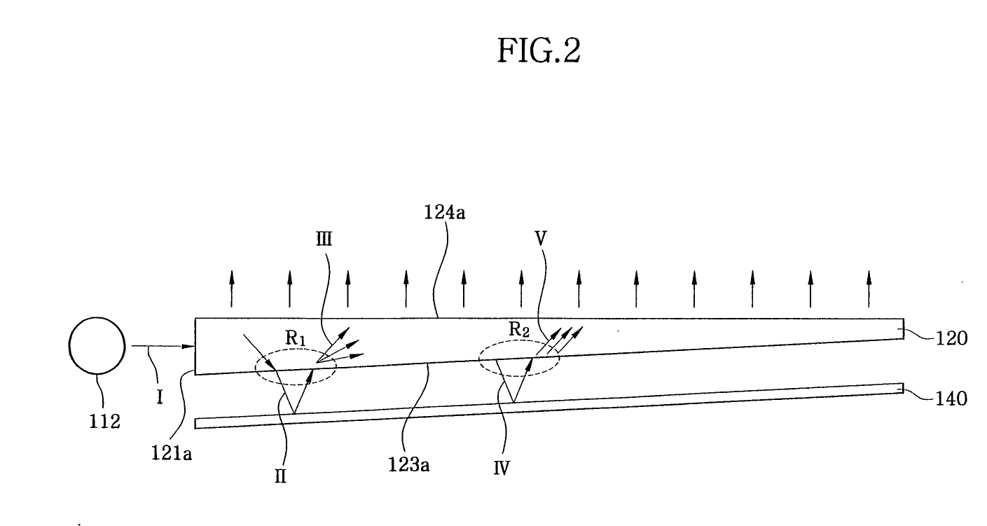

FIG. 2 is a schematic view showing a light path in a light-guide plate.

Referring to FIGS. 1 and 2, the first light generated from the lamp 112 is incident onto a light incident face 121a. A first light I is incident onto a light incident face 121a. A light guide plate guides the first light. A first portion of the first light exits toward a liquid crystal display panel (not shown) disposed over the light guide plate 120. A second portion of the second light is refracted on a bottom face 123a of the light guide plate 120 to be transformed into a second light II.

The second light II is reflected on a reflection sheet 140, so that the second light II advances toward the liquid crystal display panel. The second light II is refracted diffusively on the bottom face 123a by a first amount to be transformed into a third light III.

Then the light guide plate 120 guides the third light III. A third portion of the third light is refracted on the light exiting face 124a, so that the third portion of light advances toward the liquid crystal display panel. A fourth portion of the third light is refracted on a bottom face 123a of the light guide plate 120 to be transformed into a fourth light IV.

The fourth light IV is reflected on a reflection sheet 140, so that the fourth light IV advances toward the liquid crystal display panel. The fourth light IV is refracted diffusively on the bottom face 123a by a second amount to be transformed into a fifth light V. The second amount is larger than the first amount. Because, a prism of first region R1 where the second light II is refracted diffusively has round shape, and a ridge of the second region R2 where the fourth light IV is refracted diffusively is has triangular shape that has flat side.

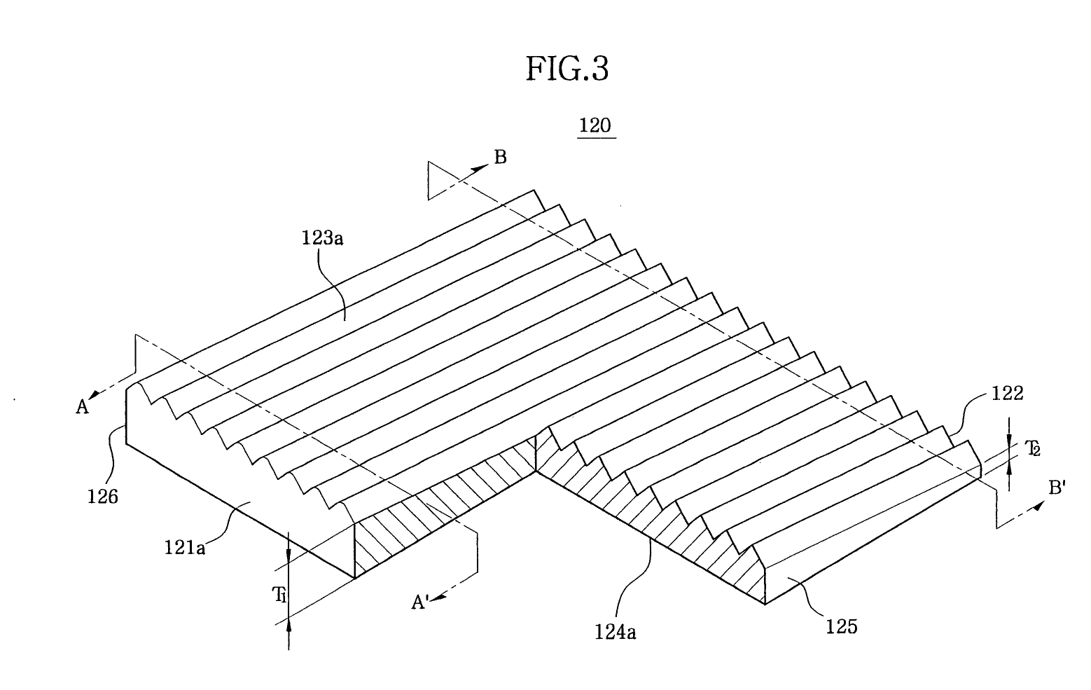

FIG. 3 is a perspective view showing the light-guide plate of FIG. 1.

Referring to FIGS. 1 and 3, the light guide plate 120 includes a light incident face 124a, a rear face 122 facing the light incident face 124a, a light exiting face 124a, a bottom face 123a including a plurality of first prisms, a first side face 125 and a second side face 126 to form a hexahedron shape. A portion of the light guide plate 120 is cut out in FIG. 3 for convenience of explanation. The bottom face 123a faces the reflection sheet 140 of FIG. 1 and the light exiting face 124a faces the light luminance control member 130 of FIG. 1.

The light generated from the lamp 112 is incident onto the light incident face 121a. Then, the light guide plate 120 guides the light incident onto the light incident face 121a, such that the light exits from the light exiting face 124a.

A lower edge of the light incident face 121a disposed adjacent to the light exiting face 124a has a straight line. An upper edge of the light incident face 121a disposed adjacent to the bottom face 123a has a ripple-shape. A ridge of the ripple has a round shape such as a parabola shape, and a valley of the ripple may have a sharp shape or a round shape. A height of the light incident face 121a is referred to as a first height T₁ that is the distance between the lower edge of the light incident face 121a and the valley of the ripple-shaped upper edge.

A lower edge of the rear face 122 disposed adjacent to the light exiting face 124a has a straight line shape. An upper edge of the rear face 122 disposed adjacent to the bottom face 123a has a saw-tooth shape. Both of a ridge of the upper edge of the rear face 122 may have a sharp shape. A valley of the upper edge of the rear face 122 may have a sharp shape or a round shape. A height of the rear face 122 is referred to as a second height T₂ that is the distance between the lower edge of the rear face 122 and the valley of the saw-tooth shaped upper edge. The rear face 122 faces the light incident face 121a. The light guide plate 120 is a wedge type light guide plate. Therefore, the second height T₂ is shorter than the first height T₁.

The bottom face 123a includes a first rim, a second rim, a third rim and a fourth rim to form a rectangle shape. The first rim neighbors the light incident face 121a. The second rim neighbors the rear face 122. The third rim neighbors the first side face 125. The fourth rim neighbors the second side face 126. The bottom face 123a faces the light reflection sheet 140 disposed under the light guide plate 120, so that the light reflected from the light reflection sheet 140 is incident onto the bottom face 123a.

The light exiting face 124a faces the light luminance control member 130, so that the light exiting from the light exiting face 124a advances toward the light luminance control member 130.

The light guide plate may be formed via various manners. For example, the light guide plate 120 having the first prisms that have partially round shape may be integrally formed through an injection molding method. The ridge of the first prisms having the sharp shape may be treated to have a round shape. A first portion of a light guide plate having round prisms may be combined with a second portion of a light guide plate having sharp prisms, so that the light guide plate 120 having the first prisms that have partially round shape is formed.

The first side face 125 includes four rims to have a rectangular shape. A first rim of the first side face 125 neighbors the light incident face 121a. A second rim of the first side face 125 neighbors the rear face 122. A third rim of the first side face 125 neighbors the bottom face 123a. A fourth rim of the first side face 125 neighbors the light exiting face 124a.

Likewise, the second side face 126 includes four rims to have rectangular shape. A first rim of the second side face 126 neighbors the light incident face 121a. A second rim of the second side face 126 neighbors the rear face 122. A third rim of the second side face 126 neighbors the bottom face 123a. A fourth rim of the second side face 126 neighbors the light exiting face 124a.

In FIG. 3, the depths of the valleys of the first prisms are equal with each other. The height of the first prisms is equal with each other. Angle s of the apexes of the first prisms may be equal with each other. However, the depths of the valleys, the heights of the first prisms and the angle of the first prisms may be different with each other.

A longitudinal direction of each of the first prisms is substantially perpendicular to a longitudinal direction of a lamp. However, the longitudinal direction of each of the first prisms may form a predetermined angle with respect to the longitudinal direction of the lamp.

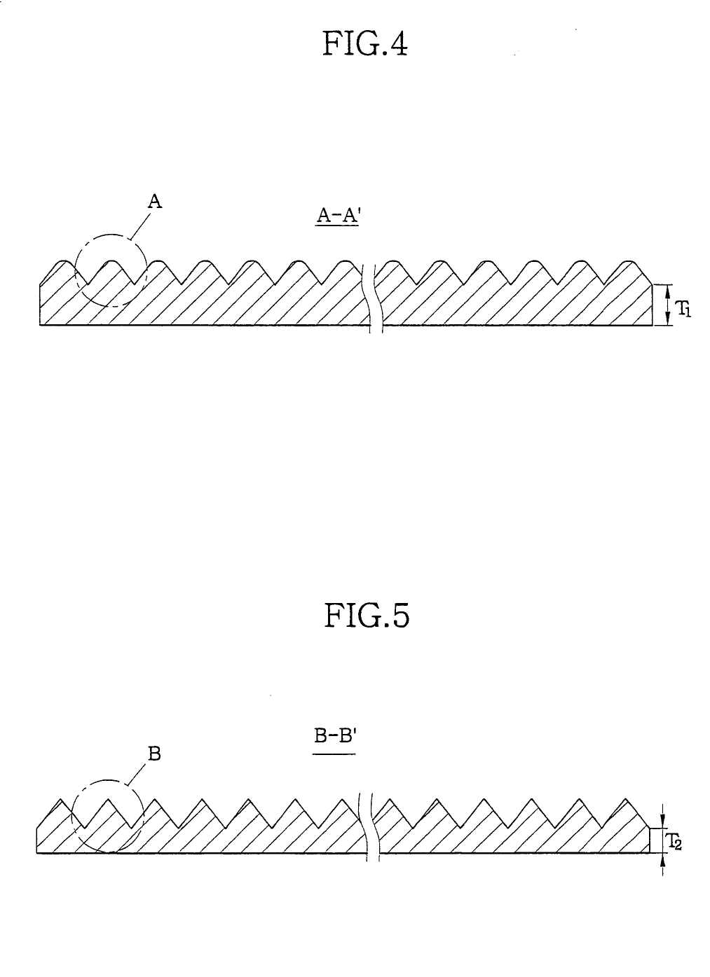

FIG. 4 is a cross-sectional view showing a light guide plate taken along the line A-A′ of FIG. 3.

Referring to FIG. 4, a cross-section of taken along the line A-A′ disposed near the light incident face 121a of FIG. 3 has an upper edge having a ripple-shape and a lower edge having a straight line. A ridge of the ripple-shape is round, but a valley of the ripple-shape is sharp. The ripple-shaped upper edge corresponds to the bottom face 123a of FIG. 3, and the straight line shaped lower edge corresponds to the light exiting face 124a of FIG. 3. The valley of the ripple-shaped upper edge is spaced apart from the straight line shaped lower edge by the first height T₁.

The ripple shaped upper edge refracts the second light II of FIG. 2 diffusively.

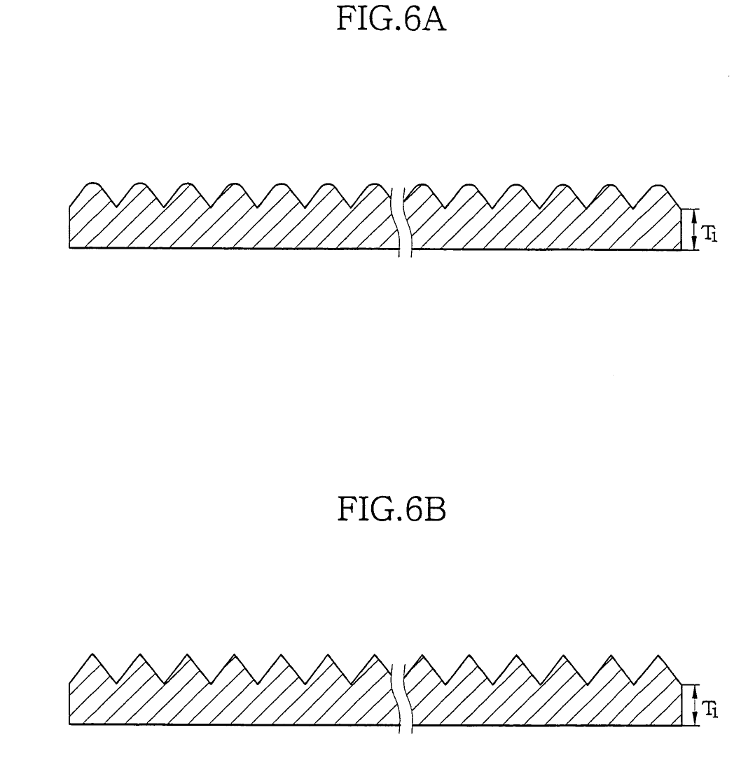

FIG. 5 is a cross-sectional view showing a light-guide plate taken along the line B-B′ of FIG. 3.

Referring to FIG. 5, a cross-section of taken along the line B-B′ disposed near the rear face 122 of FIG. 3 has an upper edge having a saw-tooth-shape and a lower edge having a straight line shape. Both of a ridge of the upper edge and a valley of the upper edge have sharp shapes. The upper edge having the saw-tooth-shape corresponds to the bottom face 123a of FIG. 3, and the lower edge having the straight line shape corresponds to the light exiting face 124a of FIG. 3. The valley of the saw-tooth-shaped upper edge is spaced apart from the lower edge having the straight line shape by the second height T₂. The second height T₂ is smaller than the first height T₁.

The ripple shaped upper edge diffusively refracts and diffuses the second light II, the fourth light IV and the sixth light VI reflected from the reflection sheet 140 of FIG. 1.

The saw-tooth-shaped upper edge refracts the fourth light IV of FIG. 2 diffusively.

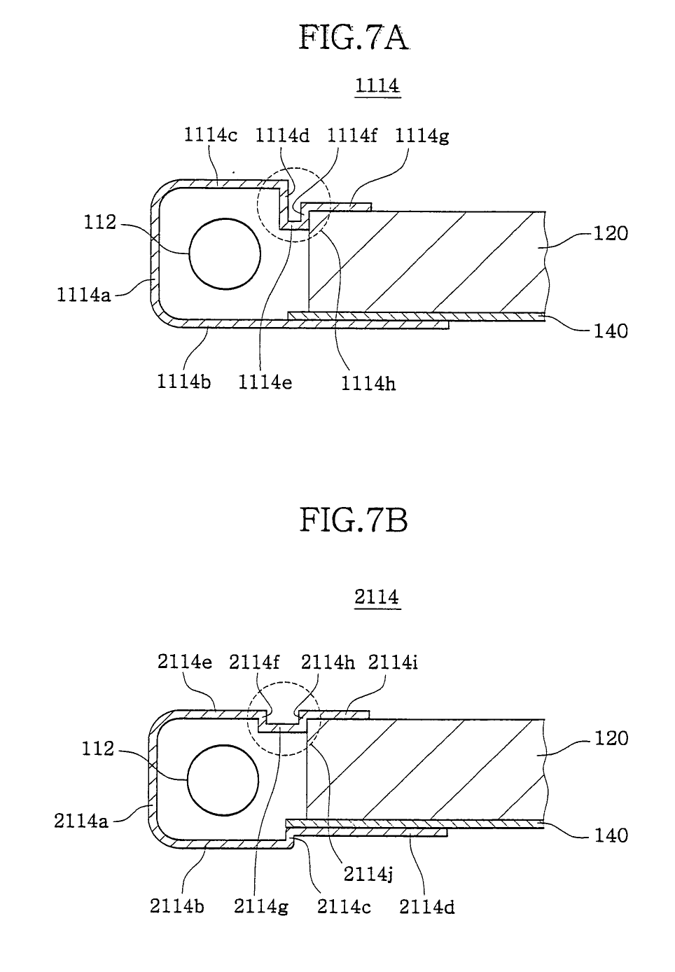

FIG. 6A is a cross-sectional view taken along a line disposed near and parallel to a light incident face showing a flat type light-guide plate, and FIG. 6B is a cross-sectional view taken along a line disposed between the two light incident face showing a flat type light-guide plate.

FIG. 6A is a cross-sectional view of a light incident face of a flat type light guide plate according to a second exemplary embodiment and FIG. 6B is a cross-sectional view of the opposite face facing the light incident face of the flat type light guide plate according to the second exemplary embodiment.

Referring to FIG. 6A, a cross-section of an upper edge of a light incident face of the flat type light guide plate has a ripple-shape. The upper edge corresponds to a bottom face of the flat type light guide plate, and a lower edge of the light incident face of the flat type light guide plate has a straight line shape and corresponds to a light exiting face of the flat type light guide plate. A ridge of the ripple-shaped upper edge has a round shape, but a valley of the ripple-shaped lower edge has a sharp shape. A valley of the ripple-shaped upper edge is spaced apart from the flat shaped lower edge by a first height T₁.

Referring to FIG. 6B, a cross-section of an upper edge of the light incident face of the flat type light guide plate has a saw-tooth shape. The upper edge of the light incident face of the flat type light guide plate corresponds to a bottom face of the flat type light guide plate, and a lower edge of the light incident face of the flat type light guide plate has a straight line shape and corresponds to a light exiting face of the flat type light guide plate. Both a ridge of the saw-tooth shaped upper edge and a valley of the saw-tooth shaped upper edge has sharp shape. A valley of the saw-tooth shaped upper edge also spaced apart form the straight line shaped lower edge by the first height T₁, because the flat type light guide plate has substantially uniform thickness.

A ridge of a first portion of the first prisms disposed near the light incident face has a round shape, and a ridge of a second portion of the first prisms disposed far from the light incident face has a sharp shape, so that the bright line decreases.

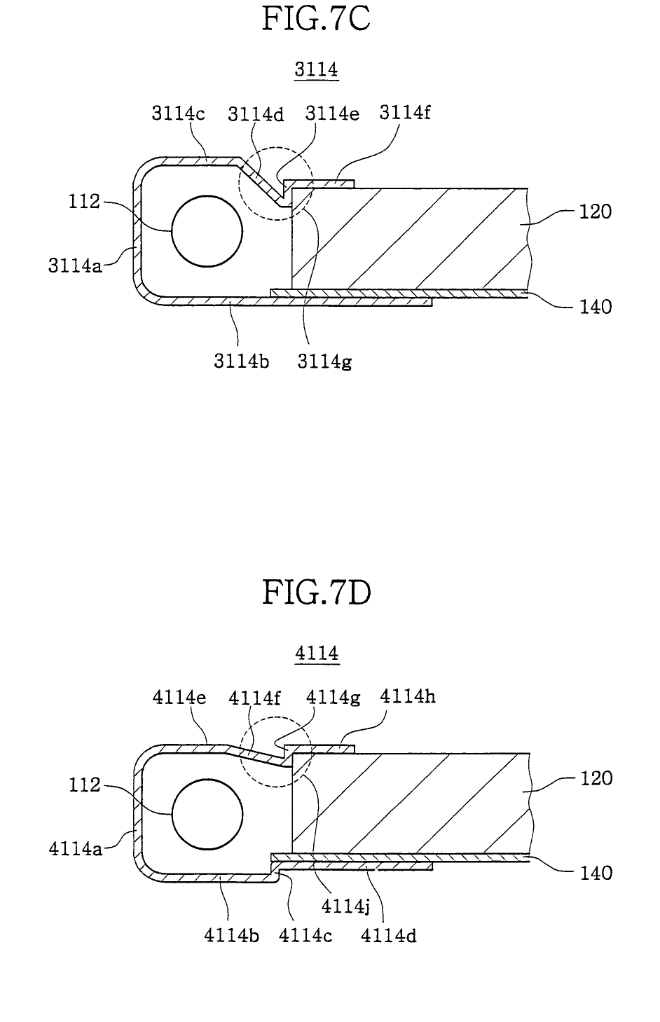

FIG. 7A is a cross-sectional view showing a lamp cover of back light assembly according to a third exemplary embodiment.

Referring to FIG. 7A, a lamp cover 1114 according to a third exemplary embodiment includes a body portion 1114a, a lower portion 1114b, an upper portion 1114c, a third portion 1114d, a fourth portion 1114e, a fifth portion 1114f and a sixth portion 1114g.

The body portion 1114a faces a light incident face 121a of a light guide plate 120. A lamp 112 is disposed between the body portion 1114a and the light incident face 121a. The first portion 1114b is elongated horizontally from a lower end of the body portion 1114a. The first portion 1114b supports a reflection sheet 140 and light guide plate 120 disposed on the reflection sheet 140. The second portion 1114c is elongated horizontally from an upper end of the body portion 1114a to face the first portion 1114b. The third portion 1114d is elongated downward from the second portion 1114c to face the body portion 1114a. The fourth portion 1114e is elongated horizontally from the third portion 1114d. The fifth portion 1114f is elongated upward from the fourth portion 1114e to face the third portion 1114d. The sixth portion 1114g is elongated horizontally from the fifth portion 1114f. The sixth portion 1114g makes contact with an upper edge portion of a light exiting face of the light guide plate 120. The upper edge portion of the light exiting face of the light guide plate 120 disposed adjacent to the light incident face 121a of the light guide plate 120.

A bright line appears on a liquid crystal display panel (not shown) disposed over the light guide plate 120 due to the light incident from the upper edge portion of the light guide plate 120. Therefore, when a covering portion 1114h formed by the third portion 1114d, the fourth portion 1114e and the fifth portion 1114f covers an upper edge portion of the light guide plate 120, the bright line formed on the liquid crystal display panel may be reduced.

FIG. 7B is a cross-sectional view showing a lamp cover of a back light assembly according to a fourth exemplary embodiment.

Referring to FIG. 7B, a lamp cover 2114 according to a fourth exemplary embodiment includes a body portion 2114a, a first portion 2114b, a second portion 2114c, a third portion 2114d, a fourth portion 2114e, a fifth portion 2114f, a sixth portion 2114g, a seventh portion 2114h and a eighth portion 2114i.

The body portion 2114a faces light incident face 121a of a light guide plate 120. A lamp 112 is disposed between the body portion 2114a and the light incident face 121a. The first portion 2114b is elongated horizontally from a lower end of the body portion 2114a. The second portion 2114c is elongated upward from the first portion 2114b to face the body portion 2114a. The third portion 2114d is elongated horizontally from the second portion 2114c. The third portion 2114d supports a reflection sheet 140 and a light guide plate 120 disposed on the reflection sheet 140.

The fourth portion 2114e is elongated horizontally from an upper end of the body portion 2114a to face the first portion 2114b. The fifth portion 2114f is elongated downward from the fourth portion 2114e to face the body portion 2114a. The sixth portion 2114g is elongated horizontally from the fifth portion 2114f. The seventh portion 2114h is elongated upward from the sixth portion 2114g to face the fifth portion 2114f. The eighth portion 2114i is elongated horizontally form the seventh portion 2114h. The eighth portion 2114i makes contact with an upper edge portion of a light exiting face of the light guide plate 120.

A bright line appears on a liquid crystal display panel (not shown) disposed the light guide plate 120 due to light incident from the upper edge portion of the light guide plate. Therefore, when a covering portion 2114j formed by the fifth portion 2114f, the sixth portion 2114g and the seventh portion 2114h covers the upper edge portion of the light guide plate 120, the bright line formed on a liquid crystal display panel is reduced. Further, forming the second portion 2114c forms an enough space for receiving the lamp 112.

FIG. 7C is a cross-sectional view showing a lamp cover of a back light assembly according to a fifth exemplary embodiment.

Referring to FIG. 7C, a lamp cover 3114 according to a fifth exemplary embodiment includes a body portion 3114a, a first portion 3114b, a second portion 3114c, a third portion 3114d, a fourth portion 3114e and a fifth portion 3114f.

The body portion 3114a faces light incident face 121a of a light guide plate 120. A lamp 112 is disposed between the body portion 2114a and the light incident face 121a. The first portion 3114b is elongated horizontally from lower end of the body portion 3114a. The first portion 3114b supports a reflection sheet 140 and light guide plate 120 disposed on the reflection sheet 140. The second portion 3114c is elongated horizontally from upper end of the body portion 3114a to face the first portion 3114b. The third portion 3114d is elongated from the second portion 3114c toward the light incident face 121a of the light guide plate 120. The third portion 3114d forms a predetermined angle with respect to the second portion 3114c. The fourth portion 3114e is elongated upward from the third portion 3114d. The fifth portion 3114f is elongated horizontally from the fourth portion 3114e. The fifth portion 3114f makes contact with an upper edge portion of a light exiting face of the light guide plate 120.

A bright line appears on a liquid crystal display panel (not shown) disposed the light guide plate 120 due to light incident from the upper edge portion of the light guide plate. Therefore, when a covering portion 3114g formed by the third portion 3114d and the fourth portion 3114e covers the upper edge portion of the light guide plate 120, the bright line formed on a liquid crystal display panel is reduced.

FIG. 7D is a cross-sectional view showing a lamp cover of a back light assembly according to a sixth exemplary embodiment.

Referring to FIG. 7D, a lamp cover 4114 according to a sixth exemplary embodiment includes a body portion 4114a, a first portion 4114b, a second portion 4114c, a third portion 4114d, a fourth portion 4114e, a fifth portion 4114f, a sixth portion 4114g and a seventh portion 4114h.

The body portion 4114a faces light incident face 121a of a light guide plate 120. A lamp 112 is disposed between the body portion 4114a and the light incident face 121a. The first portion 4114b is elongated horizontally from a lower end of the body portion 4114a. The second portion 4114c is elongated upward from the first portion 4114b to face the body portion 4114a. The third portion 4114d is elongated horizontally from the second portion 4114c. The third portion 4114d supports a reflection sheet 140 and a light guide plate 120 disposed on the reflection sheet 140.

The fourth portion 4114e is elongated horizontally from an upper end of the body portion 4114a to face the first portion 4114b. The fifth portion 4114f is elongated from the fourth portion 4114e toward the light incident face 121a of the light guide plate 120. The fifth portion 4114f forms a predetermined angle with respect to the fourth portion 4114e. The sixth portion 4114g is elongated upward from the fifth portion 4114f. The seventh portion 4114h is elongated horizontally from the sixth portion 4114g. The seventh portion 4114h makes contact with an upper edge portion of a light exiting face of the light guide plate 120.

A bright line appears on a liquid crystal display panel (not shown) disposed the light guide plate 120 due to light incident from upper edge portion of the light guide plate. Therefore, when a covering portion 4114i formed by the fifth portion 4114f and the sixth portion 4114g covers the upper edge portion of the light guide plate 120, the bright line formed on a liquid crystal display panel is reduced. Further, forming the second portion 4114c forms an enough space for receiving the lamp 112.

Hereinbefore, the lamp covers 1114, 2114, 3114 and 4114 cover the upper edge portion of the light guide plate 120, such that the bright line formed on the liquid crystal display panel is reduced.

Hereinafter, other method for reducing the bright line is disclosed. When a light incident face of the light guide plate is disposed as far as possible from an active display region, the bright line appearing in a liquid crystal display panel disposed over the light guide plate is reduced.

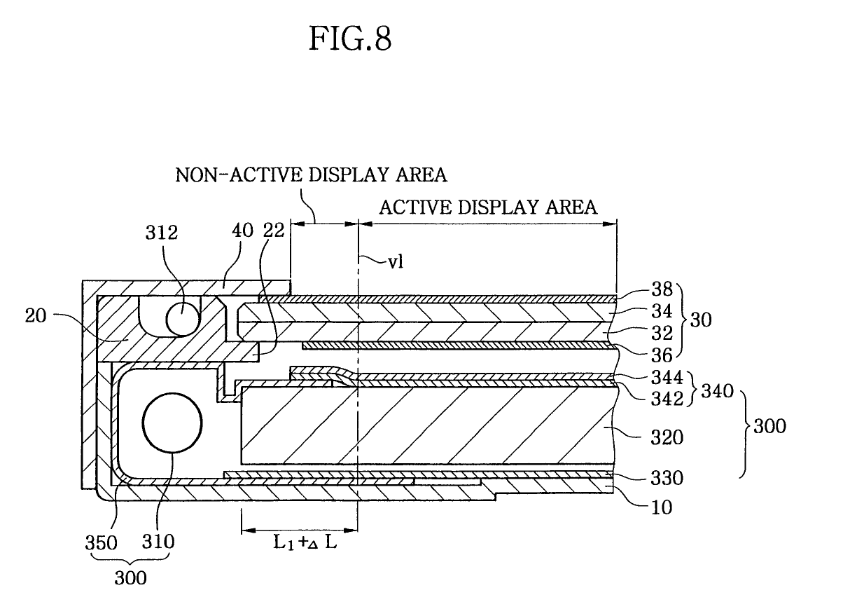

FIG. 8 is a cross-sectional view showing a liquid crystal display device according to a seventh exemplary embodiment.

Referring to FIG. 8, a liquid crystal display device according to seventh exemplary embodiment includes a bottom chassis 10, a back light assembly 300, a mold frame 20, a liquid crystal display panel 30 and a top chassis 40.

The bottom chassis 10 forms a receiving space for receiving the back light assembly 300. The mold frame 20 having a protruding portion 22 is disposed over the back light assembly 300. The protruding portion 22 of the mold frame 20 supports the liquid crystal display panel 30. The top chassis 40 is combined with the bottom chassis 10, so that the liquid crystal display panel 30 is fixed.

The bottom chassis 10 has a rectangular shape in accordance with the shape of the liquid crystal display panel 30. The bottom chassis 10 forms a receiving space. The back light assembly 300 is disposed in the receiving space. Although not shown in FIG. 8, the bottom chassis 10 has a protruding portion bent inward to prevent the separation of the mold frame 20. Although not shown in FIG. 8, the bottom chassis 10 may have a through-hole through which the top chassis 40 is combined with a side face of the bottom chassis 10. A bottom face of the bottom chassis 10 has irregular shape according to a contour of the back light assembly 300. However, the bottom face of the bottom chassis 10 may have a flat surface.

The back light assembly 300 includes a lamp 310, a light guide plate 320, a reflection sheet 330 disposed under the light guide plate 330, optical sheets 340 disposed on the light guide plate 320 and a lamp cover 350. The lamp cover 350 contacts with an upper edge portion of the light guide plate 320 and a lower edge portion of the reflection sheet 330 to form a receiving space. The receiving space receives the lamp 310.

A display region of the liquid crystal display device is divided into an active display region and a non-active display region. The active display region is referred to as a region on which an image is displayed, and the non-active display region is referred to as a region on which an image is not displayed since peripheral devices for driving the liquid crystal display device are disposed in the non-active display region. A virtual line VL divides the liquid crystal display device into the active display region and the non-active display region.

A light incident face 320a of the light guide plate 320 is disposed from the virtual line VL as far as possible. Namely, when a light incident face of a conventional liquid crystal display device is spaced apart from the virtual line VL by a first distance L1, a light incident face of a liquid crystal display device according to a seventh exemplary embodiment is spaced apart from the virtual line VL by a second distance L1+ΔL. Therefore, the light incident face 320a of the liquid crystal display device is farther from the virtual line VL than the light incident face 320a of the liquid crystal display device by a distance ΔL than that of the conventional liquid crystal display device. The light guide plate 320 includes a plurality of prisms. The prisms are formed on a bottom face of the light guide plate 320 to face the reflection sheet 330.

When an edge portion, which have the light incident face 320a of the light guide plate 320, of a light guide plate is elongated from L1 to L1+ΔL, so that a light incident face of the light guide plate is disposed closer to a lamp than that of the conventional light guide plate, a bright line that appears on a liquid crystal display panel disposed over the light guide plate may be reduced.

The mold frame 20 is disposed over the back light assembly 300. The mold frame 20 is combined with the bottom chassis 10. The mold frame 20 has the protruding portion 22. The protruding portion 22 supports the liquid crystal display panel 30. The mold frame 20 is combined with the top chassis 40 also. A groove is formed on the mold frame 20. The groove receives a wire for supplying the lamp 310 with electric power.

The liquid crystal display panel 30 includes an array substrate 32, a color filter substrate 34, a first polarizing plate 36 and a second polarizing plate 38.

The color filter substrate 34 is disposed over the array substrate 32. The first polarizing plate 36 is disposed on a lower surface of the array substrate 32. The second polarizing plate 38 is disposed on the color filter substrate 34. The liquid crystal display panel 30 is supported by the protruding portion 22 of the mold frame 20 and display an image.

The top chassis 40 is combined with the mold frame 20 and the bottom chassis 10 to prevent the separation of the liquid crystal display panel 30.

A first light-shielding member may reduce the bright line, which appears on the liquid crystal display panel. Hereinafter, the first light-shielding member is disclosed.

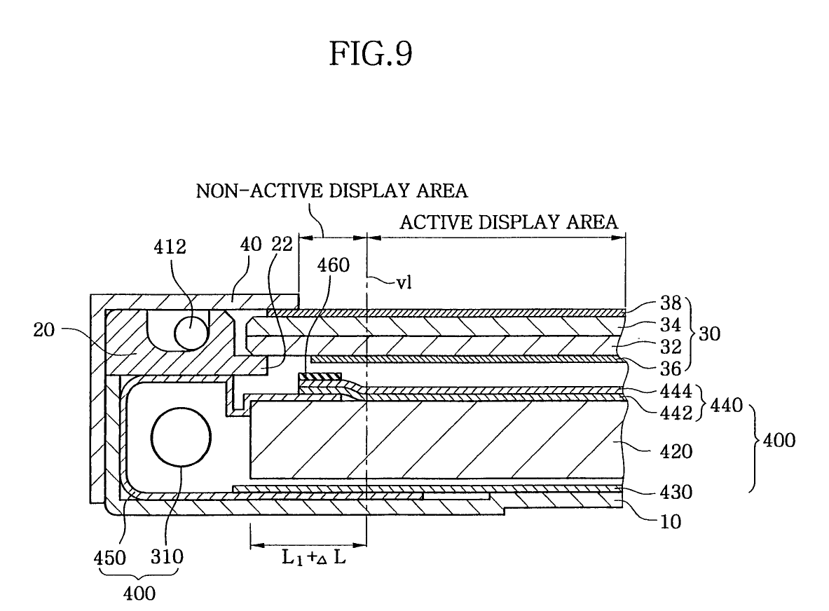

FIG. 9 is a cross-sectional view showing a liquid crystal display device according to an eighth exemplary embodiment.

Referring to FIG. 9, a liquid crystal display device according to an eighth embodiment includes a bottom chassis 10, a back light assembly 400, a mold frame 20, a liquid crystal display panel 30 and a top chassis 40.

The bottom chassis 10 forms a receiving space for receiving the back light assembly 400. The mold frame 20 having a protruding portion 22 is disposed over the back light assembly 400. The protruding portion 22 of the mold frame 20 supports the liquid crystal display panel 30. The top chassis 40 is combined with the bottom chassis 10, so that the liquid crystal display panel 30 is fixed.

In FIG. 9, the same reference numerals will be used to refer to the same or like parts as those shown in the in FIG. 8. The back light assembly 400 includes a lamp 410, a light guide plate 420, a reflection sheet 430, optical sheets 440 (or light luminance control member), a lamp cover 450 and first light-shielding member 460. The reflection sheet 430 is disposed under the light guide plate 420. The optical sheets are disposed on the light guide plate 420. The lamp cover 450 contacts an upper edge portion of the light guide plate 420 and the reflection sheet 430 to form a receiving space. The receiving space receives the lamp 410. The first light-shielding member 460 shields the light exiting from the optical sheets 440, and is formed in the non-active display region and is disposed on a portion of the optical sheets 440. The portion of the optical sheets 440 is disposed adjacent to the light incidence face 320a of the light guide plate 420, thereby reducing a bright line due to the lamp. The optical sheets may include a light-diffusion sheet 442 and a light-concentration sheet 444. The light-diffusion sheet 442 diffuses the light guided by the light guide plate 420. The light concentration sheet 444 may include one sheet or a plurality of sheets. The light concentration sheet 444 is disposed on the light-diffusion sheet 442 to concentrate the light diffused by the light diffusion sheet 442.

The first light-shielding member 460 may be manufactured in various manners, and the first light-shielding member 460 may have various shapes. For example, a pattern for shielding light may be printed on the optical sheets 440 so as to form the first light-shielding member 460. A tape for shielding light may be attached onto the upper face of the optical sheets 440 so as to form the first light-shielding member 460.

The first light-shielding member 460 is formed in the non-active display region. Therefore, the first light-shielding member 460 does not disturb an image displayed on the active display region. The first light-shielding member 460 shields the light entering into the light guide plate 420 via an upper edge portion of the light guide plate 420. Therefore, the bright line is reduced.

Further, as shown in FIG. 8, a light incident face of the light guide plate may be displaced as far as possible from the virtual line VL which divides the liquid crystal display device into an active display region and a non-active display region and as close as possible to the lamp 410. Therefore, the bright line is more reduced.

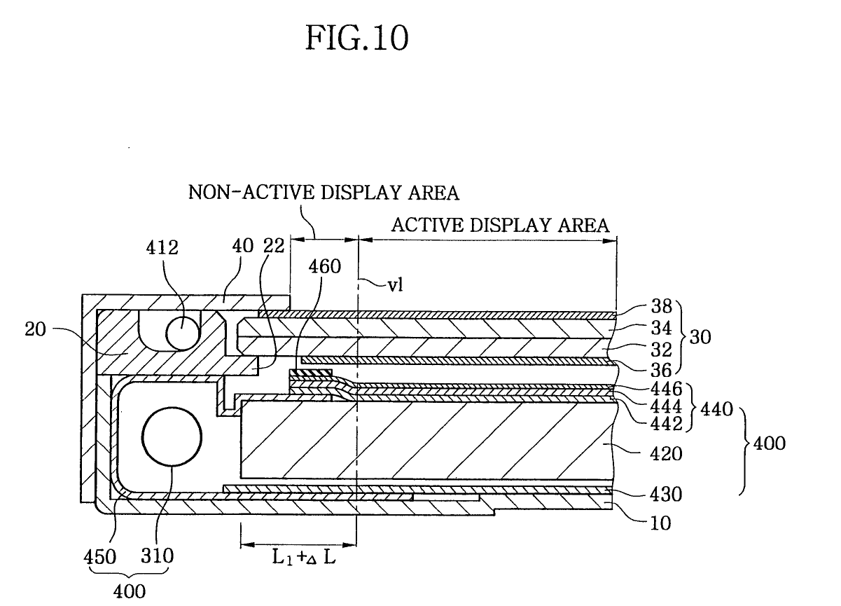

FIG. 10 is a cross-sectional view showing a liquid crystal display device according to a ninth exemplary embodiment.

Referring to FIG. 10, a liquid crystal display device according to a ninth exemplary embodiment may further include a protection sheet 446 with reference to a liquid crystal display device according to a eighth exemplary embodiment of FIG. 9.

The protection sheet 446 may be disposed on a light-concentration sheet 444 so as to protect the light-concentration sheet 444. Then, a first light-shielding member 460 may be formed on an upper edge portion of the protection sheet 446. The upper edge portion of the protection sheet 446 is disposed adjacent to the light incident face of the light guide plate 420.

Hereinbefore, the first light-shielding member 460 formed on the optical sheets 440 is disclosed. A second light-shielding member for reducing the bright line may be formed on a reflection sheet 430.

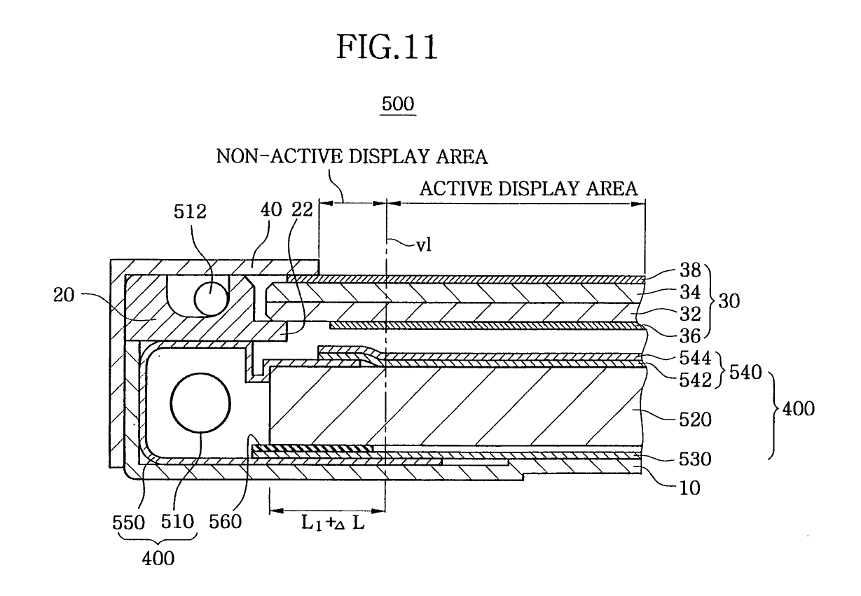

FIG. 11 is a cross-sectional view showing a liquid crystal display device according to a tenth exemplary embodiment.

Referring to FIG. 11, a liquid crystal display device according to a tenth embodiment includes a bottom chassis 10, a back light assembly 500, a mold frame 20, a liquid crystal display panel 30 and a top chassis 40.

The bottom chassis 10 forms a receiving space for receiving the back light assembly 300. The mold frame 20 having a protruding portion 22 is disposed over the back light assembly 300. The protruding portion 22 of the mold frame 20 supports the liquid crystal display panel 30. The top chassis 40 is combined with the bottom chassis 10, so that the liquid crystal display panel 30 is fixed.

In FIG. 11, the same reference numerals will be used to refer to the same or like parts as those shown in the in FIG. 8.

The back light assembly 500 includes a lamp 510, a light guide plate 520, a reflection sheet 530, Optical sheets 540, a lamp cover 550 and a second light-shielding member 560. The reflection sheet 530 is disposed under the light guide plate 520. The optical sheets 540 are disposed on the light guide plate 520. The lamp cover 550 is combined with the light guide plate 520 and the reflection sheet 530 and receives a lamp 510. The second light-shielding member 560 is formed in the non-active display region and on a portion of the reflection sheet 530. The potion of the reflection sheet 530 is disposed adjacent to the light incident face of the light guide plate 520.

The optical sheets 540 may include a light-diffusion sheet 542 and a light-concentrating sheet 544. The light-diffusion sheet 542 diffuses the light guided by the light guide plate 520. The light-concentration-sheet 544 may include one sheet or a plurality of sheet. The light-concentration sheet 544 is disposed on the light-diffusion sheet 542. The light-concentration sheet 544 concentrates the light diffused by the light-diffusion sheet 542.

The light-shielding member 560 is disposed in the non-active display region. Therefore, the light-shielding member 560 does not disturb an image displayed on an active-display region.

The light-shielding member 560 prevents the light from being incident into an upper edge portion of the light guide plate 520. Therefore, the bright line due to the light incident into the upper edge portion of the light guide plate 520.

Further, as shown in FIG. 11, a light incident face 320a of the light guide plate may be displaced as far as possible from the virtual line VL which divides the liquid crystal display device into an active display region and a non-active display region, and disposed as close as possible to the light incident face of the light guide plate 520. Therefore, the bright line is more reduced.

In brief, the bright lines that appear on the liquid crystal display panel are reduced since the light incident into the upper edge portion of the light guide plate is reduced.

The light incident into the upper edge portion of the light guide plate may be reduced by the following structures of the backlight assembly.

First, the ridge of the first portion of the first prisms, disposed adjacent to the light incident face of the light guide plate, has a round shape, so that the light incident into the upper edge portion of the light guide plate is reduced.

Second, the lamp cover has protruding portion covering the upper edge portion of the light guide plate, so that the bright line is reduced.

Third, the light incident face of the light guide plate is far from a virtual line that divides a liquid crystal display panel into an active display region and a non-active display region, and is as close as possible to the lamp 510, so that the bright line is reduced.

While the exemplary embodiments of the present invention and its advantages have been described in detail, it should be understood that various changes, substitutions and alterations can be made herein without departing from the spirit and scope of the invention as defined by appended claims.

1. A method of guiding a light toward a liquid crystal display panel, the method comprising:
receiving a first light generated from a light source;
guiding the first light to refract a first portion of the first light toward the liquid crystal display panel and to refract a second portion of the first light toward an opposite direction to transform the second portion of the first light into a second light;
reflecting the second light toward the liquid crystal display panel;
diffusively refracting the second light by a first amount to transform the second light into a third light;
guiding the third light to refract a third portion of the third light toward the liquid crystal display panel and to refract a fourth portion of the third light toward the opposite direction to transform the fourth portion of the third light into a fourth light;
reflecting the fourth light toward the liquid crystal display panel;
diffusively refracting the fourth light by a second amount to transform the fourth light into a fifth light, such that the second amount is larger than the first amount; and
refracting the fifth light toward the liquid crystal display panel.

2. The method for guiding light of claim 1, wherein the second light is reflected on a first region, and the fourth light is reflected on a second region, the first region being spaced apart from the light source by a first distance, the second region being spaced apart from the light source by a second distance, the second distance being larger than the first distance.

3. A light guiding apparatus comprising:
a light incident face onto which a light generated from a light source is incident;
a rear face facing the light incident face;
a first side face connecting the light incident face with the rear face;
a second side face connecting the light incident face with the rear face, the second side face facing the first side face;
a bottom face having a plurality of prisms being disposed in parallel, a longitudinal direction of the prisms corresponding to a first direction, the prisms having a first portion and a second portion, the first portion being adjacent to the light incident face, the second portion being adjacent to the rear face, a cross-section of the first portion having a ripple-shape, a ridge of the first portion being round; and
a light exiting face facing the bottom face.

4. The light guiding apparatus of claim 3, wherein a cross-section of the second portion has a saw-tooth shape.

5. The light guiding apparatus of claim 3, wherein the first direction forms a predetermined angle with respect to a longitudinal direction of the light source.

6. The light guiding apparatus of claim 3, wherein the first direction is from the light incident face to the rear face being substantially perpendicular to a longitudinal direction of the light source.

7. The light guiding apparatus of claim 3, wherein a height of the light incident face is substantially equal to a height of the rear face.

8. The light guiding apparatus of claim 3, wherein a height of the light incident face is larger than a height of the rear face.

9. A lamp covering device for covering a lamp and for reflecting a light generated from the lamp toward a light incident face of a light guide plate, the lamp disposed adjacent to the light incident face, the lamp covering device comprising:
a body portion facing the light incident face of the light guide plate;
a lower portion elongated from a lower end of the body portion toward a lower face of the light guide plate; and
an upper portion elongated from an upper end of the body portion toward an upper face of the light guide plate, the upper portion including a covering portion for covering an upper edge adjacent to the light incident face of the light guide plate.

10. The lamp covering device of claim 9, wherein the covering portion comprises a first portion elongated from the upper portion in substantially parallel with the body portion toward the lower portion, a second portion elongated in substantially parallel with the lower portion from the first portion, and a third portion elongated from the second portion to cover the upper edge adjacent to the light incident face of the light guide plate.

11. The lamp covering device of claim 9, wherein the covering portion comprises a first portion elongated from the upper portion in a predetermined angle with respect to the upper portion toward the light incident face of the light guide plate, a second portion elongated from the first portion to cover the upper edge adjacent to the light incident face of the light guide plate.

12. The lamp covering device of claim 9, wherein the lower portion is disposed under a virtual line extended from a lower surface of the light guide plate, and the lower portion further includes a first portion elongated from the lower portion toward the upper portion, and a second portion elongate in parallel with the body portion from the first portion, such that the covering member for receiving a lamp provides an increased receiving space for receiving the lamp.

13. A back light assembly comprising:
a light source for generating a first light;
a light guiding member including i) a light incident face onto which a light generated from a light source is incident, ii) a rear face facing the light incident face, iii) a first side face connecting the light incident face with the rear face, iv) a second side face connecting the light incident face with the rear face, the second side face facing the first side face, v) a bottom face having a plurality of prisms being disposed in parallel, a longitudinal direction of the prisms corresponding to a first direction, the first portion being adjacent to the light incident face, the second portion being adjacent to the rear face, a cross-section of the first portion having a ripple-shape, a ridge of the first portion being round, vi) a light exiting face facing the bottom face; and
a light luminance controlling member disposed on the light guide member, for controlling luminance of a second light guided by the light guiding member.

14. The back light assembly of claim 13, further comprising a light reflecting member of reflecting a third light leaked from the light guiding member, the light reflection member disposed under the light guiding member.

15. The back light assembly of claim 13, further comprising a light source cover for covering the light source and for reflecting a first light generated from the light source toward a light incident face of a light guiding member, the light source disposed beside the light incident face, the light source cover comprising:
a body portion facing the light incident face of the light guide plate;
a lower portion elongated from a lower end of the body portion toward a lower face of the light guide plate; and
an upper portion elongated from an upper end of the body portion toward an upper face of the light guide plate, the upper portion including a covering portion for covering an upper edge adjacent to the light incident face of the light guide plate.

16. The back light assembly of claim 13, further comprising a light-shielding member, disposed on a portion of the light luminance controlling member, for shielding a third light exiting from the luminance controlling member, the portion being disposed adjacent to the light incidence face of the light guiding member, so that a bright line due to the light source is reduced.

17. The back light assembly of claim 13, wherein the light luminance controlling member includes a prism sheet, the prism sheet having at least one prism formed on a lower face facing the light guiding member.

18. The back light assembly of claim 17, wherein the prisms are elongated in a second direction in which the light source is elongated.

19. The back light assembly of claim 13, wherein the light luminance controlling member comprises:
a light-diffusion sheet for diffusing light guided by the light guiding member, the diffusion sheet disposed on the light guiding member; and
a light-concentration sheet for concentrating light diffused by the light-diffusion sheet, the light-concentration sheet disposed on the light-diffusion sheet, the light-concentration sheet including a light-shielding member, the light shielding member disposed on a region, the region disposed near the light incident face.

20. The back light assembly of claim 13, wherein the light luminance controlling member comprises:
a light-diffusion sheet for diffusing the second light guided by the light guiding member, the diffusion sheet disposed on the light guiding member;
a light-concentration sheet for concentrating a third light diffused by the light-diffusion sheet, the light-concentration sheet disposed on the light-diffusion sheet; and
a light-shielding member, disposed on a portion of the light-concentration sheet, the portion of the light-concentration sheet being adjacent to the light incident face.

21. The back light assembly of claim 13, wherein the light luminance controlling member comprises:
a light-diffusion sheet for diffusing the second light guided by the light guiding member, the diffusion sheet disposed on the light guiding member;
a light-concentration sheet for concentrating a third light diffused by the light-diffusion sheet, the light-concentration sheet disposed on the light-diffusion sheet;
a protection sheet for protecting the light-concentration sheet, the protection sheet disposed on the light-concentration sheet; and
a light-shielding member, disposed on a portion of the protection sheet, for the portion of the protection sheet being adjacent to the light incident face.

22. A liquid crystal display device comprising:
a back light assembly including, (a) a light source for generating a first light, (b) a light guiding member having i) a light incident face onto which a light generated from a light source is incident, ii) a rear face facing the light incident face, iii) a first side face connecting the light incident face with the rear face, iv) a second side face connecting the light incident face with the rear face, the second side face facing the first side face, v) a bottom face having a plurality of prisms being disposed in parallel, a longitudinal direction of the prisms corresponding to a first direction, the first portion being adjacent to the light incident face, the second portion being adjacent to the rear face, a cross-section of the first portion having a ripple-shape, a ridge of the first portion being round, vi) a light exiting face facing the bottom face, (c) a light luminance control member disposed on the light guide member, for controlling luminance of a second light guided by the light guiding member; and
a liquid crystal display panel for displaying an image, the liquid crystal display panel including an array substrate, a color filter substrate disposed over the array substrate and a liquid crystal layer interposed between the array substrate and the color filter substrate.

23. The liquid crystal display device of claim 22, wherein the liquid crystal display panel includes an active display region on which an image is displayed and a non-active display region, and the light incident face of the light guiding member being disposed in the non-active display region and being disposed close enough to the light source to reduce a bright line due to the light source.
